(19) United States
(12) Patent Application Publication
(10) Pub. No.: US 2008/0175143 A1
(43) Pub. Date: Jul. 24, 2008

(54) Method and system for providing protocol-based equipment redundancy

(76) Inventor: Carol Ansley, Alpharetta, GA (US)

Correspondence Address: ARRIS INTERNATIONAL, INC, 3871 LAKEFIELD DRIVE, SUWANEE, GA, 30024, US

(21) Appl. No.: 12/018,083

(22) Filed: Jan. 22, 2008

Related U.S. Application Data
(60) Provisional application No. 60/881,773, filed on Jan. 22, 2007.

(51) Int. Cl. G06F 11/00

(52) U.S. Cl. 370/221

(57) ABSTRACT

A single spare QAM modulator module, or circuit, provides redundancy for and can substitute for one of multiple spare modulator circuits corresponding to components providing signals to an HFC network when one of the component's modulator fails. Various parameters may be monitored and fed to a resource manager that determines, based on the monitored parameter information, whether a particular modulator circuit has failed. Then, the resource manager instructs content signals destined for the failed modulators be directed to the spare QAM modulator according to an IP address identifying it. Messaging of parameter information and control information occurs across a local IF network, to which the signal components and the spare modulator are coupled, using a variety of protocols, including DEPI. The resource manager may also control isolation switches at the spare modulator and at the tailed modulator to prevent non-desired signals from reaching the HFC.

### CROSS REFERENCE TO RELATED APPLICATION

This application claims priority under 35 U.S.C. 119(e) to the benefit of the filing date of Ansley, U.S. provisional patent application No. 60/881,773 entitled “IP-based head end redundancy system,” which was filed Jan. 22, 2007, and is incorporated herein by reference.

### FIELD OF THE INVENTION

This invention relates, generally, to communication network devices, and, more particularly to providing redundancy of head end equipment.

### BACKGROUND

Broadband service providers, for example cable television operators or telephony companies, may provide content to subscribers that originate from multiple sources. Multiple signal protocols may correspond to the multiple signal sources. For example, a Video on Demand (“VoD”) server, an edge QAM device and cable modem termination system (“CMTS”) may receive signals in correspondingly different formats, the formats using different protocols for transporting and processing the information carried according thereto. The equipment that delivers the signals from the various sources to subscribers is typically located at a service provider's central location. For example, components at a head end location of a cable company may include a CMTS, a VOD server and an edge QAM device. The signals at any one component may be received in a native format that differs from that of the signals received by the other devices.

To ensure that signal delivery to subscribers is not interrupted, redundancy is typically provided in each of the components. For example, a CMTS may have a spare cable access module (“CAM”) that can automatically be switched to replace a failed CAM. Similarly, the VoD server and the edge QAM may also include spare modules that can be automatically switched into operation to replace a failed module at the respective component. Before the output signals are combined and transmitted over the HFC, the signals may pass through a complex switching matrix that isolates a failed module and orients switches so that a spare module is coupled to a combiner in place of the failed module.

Turning now to the figures, FIG. 1 shows a system 2 for providing redundancy in a communication network using a switch matrix between signal processing components and an HFC network. System 2 delivers content to subscribers over an HFC network 4. Signals are typically received from a first network, for example, a private IP network 5, that the service provider controls. For purposes of discussion, a second network, of which HFC 4 is an example, and combiner 6 correspond to a service group, which corresponds to a given group of subscribers. It will be appreciated that typically a service provider may supply signals to multiple service groups from the same head end location, and even from the same component (i.e., a CMTS).

Combiner 6 combines signals that are output from components such as CMTS 8, edge QAM 10 and other devices, for example a VoD server 12. Each of the components includes a spare module, spare module 14 corresponding to CMTS 8, spare module 16 corresponding to edge QAM 10 and spare module 18 corresponding to VoD server 12. All modules from the components, including the spare modules, couple into switch matrix 20. In the downstream direction (from head end toward subscribers), switch matrix 20 typically has more inputs 22 than outputs 24, since some of the inputs correspond to the spare modules, whereas the outputs only correspond to the number of active modules from the components. It will be appreciated that each of lines 22 and 24 shown in the figure may represent more than one physical line. For example, the lines 22 connecting CMTS 8, Edge QAM 10 VoD server 12 and analog TV modulators 26 typically represent multiple lines, since multiple components, CMTS CAM card blades, for example, are included in a typical component rack unit. However, the lines 22 connecting spare modules 14, 16, 18 and 28 typically represent one line, since a given component rack typically includes one spare module that can provide back up to multiple active modules, or similar circuitry assemblies, contained in the rack.

In addition, as shown in the figure, analog television modulators 26, for example, are shown coupled to switch matrix 20. TV modulator spare module 28 is also shown coupled to matrix 20. Sometimes circuitry or parts of a component that are not part of the modulator portion of the component fail.

However, due to the stress of handing high power levels relative to other portions of a component, the modulator (or radio frequency) portion tends to be the portion that fails the most. In addition, since the modulator portion of a component is designed to handle higher power the other parts of a component, the modulator tends to comprise more expensive electronic parts than other parts of the component. Thus, including a spare modulator for each type of component is costly and deprives a given component of slot, or space for a module, that could otherwise be used for an active module.

Furthermore, until recently, the number of unique QAM channels that an operator provided from a head end was relatively small as the bulk of the channel lineup was mostly analog. The protocol that fed most of the analog modulators was a point-to-point, digital, non-switched link protocol. Most ‘redundancy’ operations involved a person using tools to repair or replace defective parts.

However, now the number of unique QAM channels provided from a head end is skyrocketing due in large part to switched digital video and video on demand service. For any given service group, the number of channels to be modulated by a QAM modulator isn't increasing, but programs can differ from one service group to another. Thus, to provide more content on demand, more and more QAM modulators are needed within the headend facility to facilitate delivering content from first network 5 to multiple service groups served by corresponding multiple HFC networks, such as HFC 4.

Therefore, there is a need in the art for a method and system that facilitates redundancy of modulators at a head end while reducing the number of spare QAM modulator circuits/modules used.

### BRIEF DESCRIPTION OF DRAWINGS

FIG. 1 illustrates a system for providing redundancy in a communication system using a switch matrix between signal processing components and an HFC network.

FIG. 2 illustrates a system for providing redundancy in a communication system using an IP-based redundancy device.

### DETAILED DESCRIPTION

As a preliminary matter, it readily will be understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The disclosure is not intended nor is to be construed to limit the present invention or otherwise to exclude any such other embodiments, adaptations, variations, modifications and equivalent arrangements, the present invention being limited only by the claims appended hereto and the equivalents thereof.

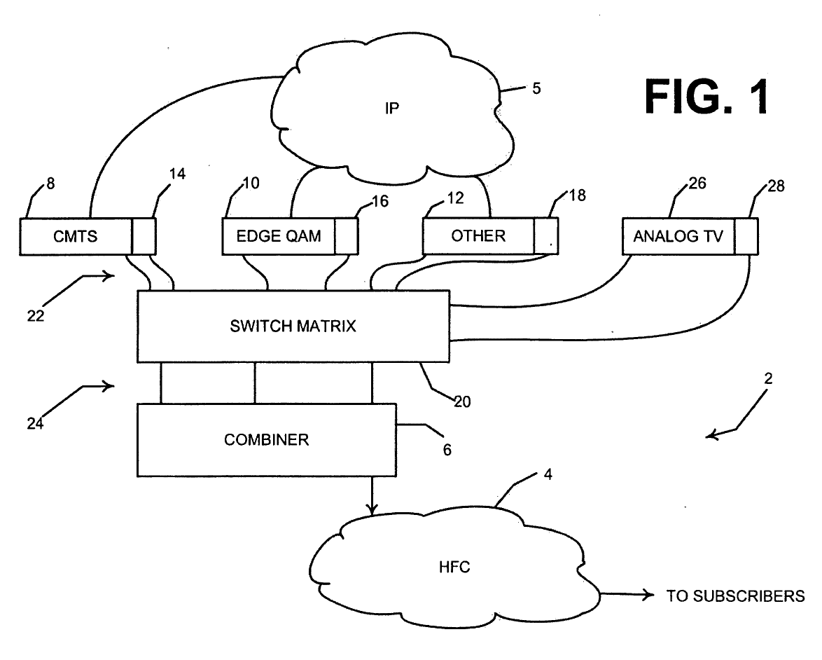

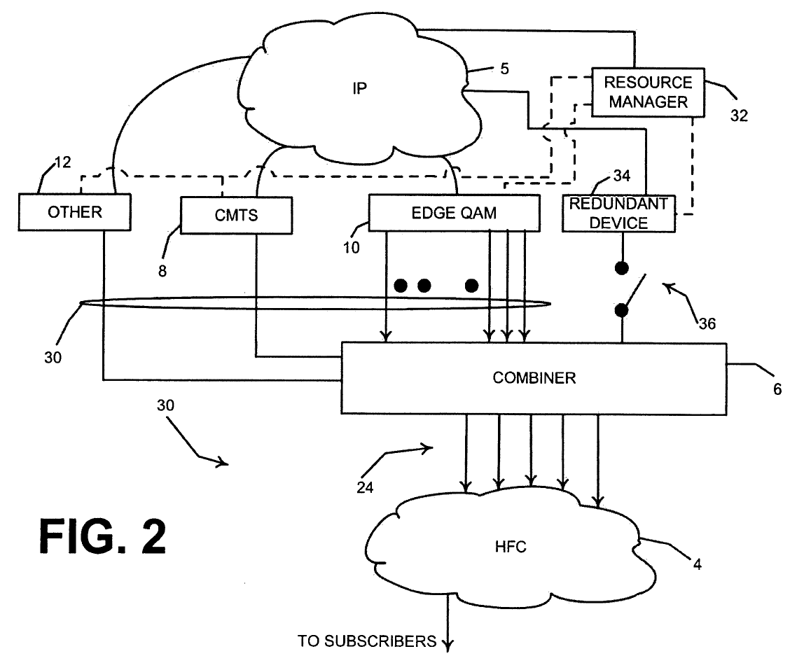

Turning now to FIG. 2, figure illustrates a system 30 for providing redundancy for QAM modulators that modulate the signals from various components. Many of the elements of system 30 are similar to those shown in FIG. 1., thus they are numbered with the same reference numbers as in FIG. 1. Continuing with discussion of FIG. 2, CMTS 8, edge QAM 10 and other components 12, for example a VoD server, are coupled to first network 5, which may be a private local area network operated by, and only accessible by, a cable provider at its head end and other locations near the head end.

In addition a resource manager 32 and redundant modulator device 34 are coupled to first network 5. Redundant modulator device 34 is connected to or isolated from combiner 6 by isolation switch 36. It will be appreciated that each of lines 22 may also be coupled to combiner 6 through corresponding isolation switches. The purpose of the isolation switches is to prevent a failed modulator corresponding to one of the switches from injecting noise, or garbled signals, into combiner 6 for further transport on to HFC 4. The isolation switches may be solid state, or preferably mechanical switches that are controlled by relays. Presently, mechanical switches provide superior conductivity at the high RF frequencies that are normally carried by HFC 4 as compared to solid state switches, but in the future solid state technology may provide a preferable switching means.

Signal components 8, 10 and 12, and redundant device 34 are controlled by resource manager 32. As known in the art, farther information and details of a resource manager may be reviewed in the Appendix 1 hereto entitled Edge Resource Manager Interface Specification, having specification number CM-SP-ERMI-I02-051209, as published by CableLabs, Inc. on Dec. 9, 2005, and which is incorporated by reference herein in its entirety and is referred to herein as “ERMI specification.” All of the components 8, 10 and 12 are coupled to first network 5, and thus can communicate with one another via protocols, typically IP protocols or other protocols as discussed in the ERMI specification.

The broken lines from resource manager 32 to the other components indicate that the resource manager can control the other components. For example, CMTS 8 may be programmed so that if one of its CAM cards fails, the CMTS sends a message to resource manager 32 that a CAM card has failed. Other means for detecting a failed component include, but are not limited to, a power level monitor at the output of an active QAM modulator, temperature and voltage monitors at a QAM modulator and a device local to the QAM modulator monitoring traffic flow (or lack thereof) at its output. Alternatively, a ‘special’ cable modem (“CM”) can be used to monitor CM-visible parameters (i.e., signals, messages, RF current, voltage, power, traffic packets, etc.) and report information regarding the monitored parameters to resource manager 32, which then determines whether a given component modulator has failed.

In response to information at resource manager 32 indicating that a CAM card, an edge QAM modulator, or VoD modulator for examples, has failed, the resource manager instructs redundant device 34 to cause isolation switch 36 to close and to process signals received from CMTS 8 from first network 5. The resource manager informs CMTS 8 of an address, such as an IP address, of redundant device 34, and instructs the CMTS to forward the content stream that was intended for the foiled CAM card modulator to the redundant device. The messaging between the various components and devices coupled to first network 5 may be transmitted according to a protocol that supports and facilitates Downstream External PHY Interface (“DEPI”). For further reference, Downstream External PHY Interface Specification (“DEPI specification”), specification number CM-SP-DEPI-I05-070223, as published Feb. 23, 2007, by CableLab, Inc., describes the DEPI protocol and how it may be used to transport signals and information between devices. The DEPI specification is attached hereto as Appendix 2 and is incorporated herein by reference in its entirety.

It will be appreciated that redundant device 34 preferably includes a QAM modulator, so resource manager 32 also instructs the redundant device the channel frequency at which to modulate the signal received from first network 5. Finally, resource manager may instruct the CMTS to initiate isolation of the failed CAM card from the combiner 6. Thus, the content that was to be sent from a QAM modulator module of CMTS 8, a module that has failed, is now transmitted to combiner 6 from redundant device 34. Therefore, system 30 provides redundancy of the components 8, 10 and 12, which are examples of components that could be supported by the system, in receiving content from first network 5 and providing the content to combiner 6 and on to HFC 4.

Typically, one spare QAM modulator is used per service group, thus reducing the number of modulators used because now each component 8, 10 and 12 does not include its own corresponding spare modulator card. This reduces the overall cost of head end equipment, the power consumed, since a spare card often is operated in hot standby mode, and the slot that would have been used at each of components 8, 10 and 12 can now be used for additional active QAM modulators, thus providing more channels in the downstream direction over HFC 4.

What is claimed is:

1. A system for providing redundancy of components coupled to a first network and a second network, comprising:
a resource manager coupled to the first network;
a redundancy device, coupled to the first network and the second network, that can function in place of one of the components; and
wherein the resource manager can determine that a modulator of one of the components has failed and can instruct the redundancy device to process signals intended for the failed modulator.

2. The system of claim 1 wherein the redundancy device can process signals being transported according to any of a plurality of protocols, the resource manager being able to instruct the redundancy device to process signals presented to it according to a protocol associated with a failed component that is one of the plurality of protocols.

3. The system of claim 1 wherein at least one of the components is an edge QAM device.

4. The system of claim 1 wherein at least one of the components is a cable modem termination system.

5. The system of claim 1 wherein at least one of the components is a video on demand server.

6. The system of claim a wherein the protocol associated with the failed components facilitates a Downstream External PHY Interface.

7. The system of claim 1 further comprising a coupler for coupling the components to the second network.

8. The system of claim 7 wherein the redundancy device corresponds to one of a plurality of sen-ice groups served by the components.

9. The system of claim 1 further comprising an isolation switch coupled between each of the component's modulators and the second network for isolating the component in response to an instruction from the resource manager.

10. The system of claim 1 wherein the redundancy device includes a QAM modulator.

11. A method for providing redundancy of components coupled to a first network and a second network, comprising:
detecting that one of the components has failed;
determining a protocol used at the failed device to process signals received from the first network;
instructing a redundancy device to process signals received from the first network according to a protocol that was used by the one of the components that has failed;
isolating the one of the failed components that has failed from the second network;
processing signals received by the redundancy device from the first network according to the protocol associated with the one of the components that has failed; and
providing the signal processed by the redundancy device from the redundancy device to the second network.
